(19) United States
(12) Patent Application Publication
(10) Pub. No.: US 2026/0296350 A1
(43) Pub. Date: Oct. 1, 2026

(54) INFORMATION PROCESSING METHOD

(71) Applicant: TOYOTA JIDOSHA KABUSHIKI KAISHA, Toyota-shi (JP)

(72) Inventors: Yuma ITO, Chiryu-shi (JP); Naoki Ueda, Nisshin-shi (JP); Shigeo Ohnogi, Aichi-gun (JP); Shingo Sugimoto, Nagoya-shi (JP); Isao Noshioka, Tokyo (JP)

(73) Assignee: TOYOTA JIDOSHA KABUSHIKI KAISHA, Toyota-shi (JP)

(21) Appl. No.: 19/453,241

(22) Filed: Jan. 20, 2026

(30) Foreign Application Priority Data
Apr. 1, 2025 (JP) 2025-060619

(51) Int. Cl. B60R 21/013; B60R 21/00; H04W 4/90; H04W 40/12

(52) U.S. Cl. CPC B60R 21/013; H04W 4/90; H04W 40/12; B60R 2021/0027

(57) ABSTRACT

The present disclosure relates to an information processing method. An in-vehicle device acquires vehicle information related to the vehicle. Next, the in-vehicle device estimates the condition of the vehicle based on the vehicle information. The in-vehicle device dynamically switches between a single communication path and multiple communication paths according to the estimated condition of the vehicle.

### CROSS-REFERENCE TO RELATED APPLICATION

This application claims priority to Japanese Patent Application No. 2025-060619 filed on Apr. 1, 2025. The disclosure of the above-identified application, including the specification, drawings, and claims, is incorporated by reference herein in its entirety.

### BACKGROUND

### 1. Technical Field

The present disclosure relates to information processing methods.

### 2. Description of Related Art

Conventionally, techniques used when an emergency event occurs in a vehicle are known in the art. For example, Japanese Unexamined Patent Application Publication No. 2020-117063 (JP 2020-117063 A) discloses an emergency notification device that sends an emergency notification when an emergency event occurs in a vehicle.

### SUMMARY

There is still room to improve the reliability of transmitting, when an emergency event occurs in a vehicle, information related to the event, such as an emergency notification.

In view of this, an object of the present disclosure is to improve the reliability of transmitting, when an emergency event occurs in a vehicle, information related to the event, such as an emergency notification.

An information processing method according to one embodiment of the present disclosure is
an information processing method executed by an in-vehicle device mounted on a vehicle.
   The information processing method includes:
acquiring information regarding whether an airbag of the vehicle has deployed, acceleration, and communication quality;
estimating that an accident has occurred in the vehicle when the airbag has deployed and an absolute value of the acceleration is greater than or equal to a first threshold; and
transmitting information related to the accident by switching from a single communication path to multiple communication paths when the communication quality is less than a second threshold.

An information processing method according to another embodiment of the present disclosure is
an information processing method executed by an in-vehicle device mounted on a vehicle.
   The information processing method includes:
acquiring vehicle information related to the vehicle;
estimating a condition of the vehicle based on the vehicle information; and
dynamically switching between a single communication path and multiple communication paths based on the estimated condition.

An embodiment of the present disclosure can improve the reliability of transmitting, when an emergency event occurs in a vehicle, information related to the event, such as an emergency notification.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to the present disclosure; and

FIG. 2 is a flowchart illustrating an operation of the in-vehicle device according to the present disclosure.

### DETAILED DESCRIPTION OF EMBODIMENTS

Hereinafter, an embodiment of the present disclosure will be described.

### Outline of Embodiment

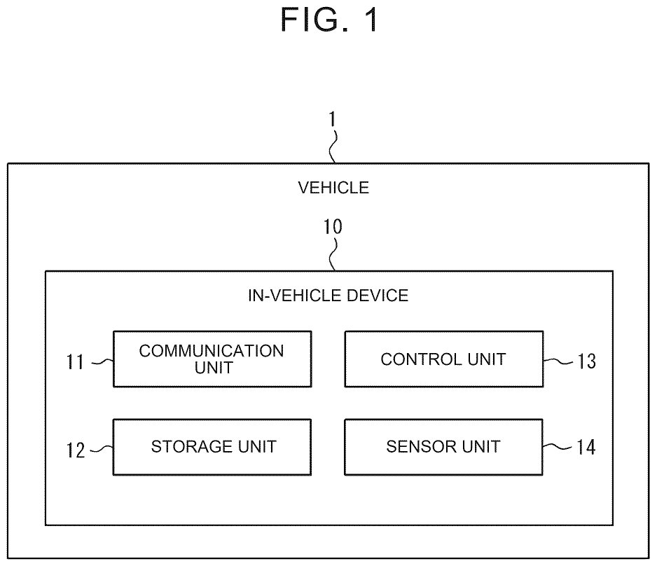

FIG. 1 is a diagram illustrating a configuration of an in-vehicle device 10 according to an embodiment. The in-vehicle device 10 is mounted on the vehicle 1. The vehicle 1 is an arbitrary vehicle such as an automobile or a two-wheeled vehicle. The in-vehicle device 10 is an information processing device having a communication function. The in-vehicle device 10 includes, for example, a DCM (Data Communication Module), a car navigation device, a drive recorder, an ECU (Electronic Control Unit), and the like.

First, the outline of the present embodiment will be described, and the details will be described later. The in-vehicle device 10 acquires vehicle information related to the vehicle 1. Next, the in-vehicle device 10 estimates the condition of the vehicle 1 based on the vehicle information. Then, the in-vehicle device 10 dynamically switches between a single communication path and multiple communication paths according to the estimated condition of the vehicle 1.

In the present embodiment, the “vehicle information” includes information on communication quality such as cellular communication and radio LAN, and information on whether or not the airbag is operated, in addition to the acceleration, velocity, position, and the like of the vehicle. The “condition of the vehicle 1” refers to any condition of the vehicle 1 such as a case where an accident occurs in the vehicle 1 and a case where the reception sensitivity of the cellular communication in the vehicle 1 is weak in an electric field. For example, when only a single communication path, such as only cellular communication, can be used in the in-vehicle device 10, communication may be delayed or interrupted in the case of a weak electric field. On the other hand, when multiple communication paths such as cellular communication and radio LAN can be used at all times in the in-vehicle device 10, for example, a cost-increasing problem occurs. On the other hand, according to the present embodiment, for example, an accident occurs in the vehicle 1, and multiple communication paths can be used only in the case of a weak electric field. Therefore, it is possible to improve certainty when transmitting information related to an event such as an emergency notification when an emergency event of a vehicle occurs.

Next, the configuration of the in-vehicle device 10 will be described in detail.

### Configuration of IN-VEHICLE DEVICE

The in-vehicle device 10 includes a communication unit 11, a storage unit 12, a control unit 13, and a sensor unit 14.

The communication unit 11 includes two or more communication interfaces that enable cellular communication, radio LAN, inter-vehicle communication, and the like. Communication interfaces include mobile communication standards used for cellular communication such as 4G (4 th Generation), 5G (5 th Generation), LTE (Long Term Evolution), etc. Further, the communication interfaces include a wireless LAN such as Wi-Fi (registered trademark) or Bluetooth (registered trademark), or a short-range wireless communication standard used for inter-vehicle communication. The communication unit 11 communicates with devices such as a terminal device, a server device, and other vehicles via a network.

The storage unit 12 includes one or more memories. The memory is, for example, a semiconductor memory, a magnetic memory, an optical memory, or the like. Each memory included in the storage unit 12 may function as, for example, a main storage device, an auxiliary storage device, or a cache memory. The storage unit 12 stores arbitrary information used for the operation of the in-vehicle device 10. For example, the storage unit 12 may store a system program, an application program, and embedded software. For example, the information stored in the storage unit 12 may be updatable by, for example, information acquired from a network via the communication unit 11.

The control unit 13 may include one or more processors, one or more programmable circuits, one or more dedicated circuits, or a combination thereof. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuitry is, for example, a ASIC (Application Specific Integrated Circuit). The control unit 13 controls the operation of the in-vehicle device 10.

The sensor unit 14 includes, for example, a plurality of sensors installed in the vehicle 1 necessary for acquiring vehicle information such as a steering angle sensor, an acceleration sensor, a vehicle speed sensor, a position sensor, and a gyro sensor. The sensor unit 14 may correspond to, for example, a GPS (Global Positioning System).

### Operation Flow of In-vehicle Device

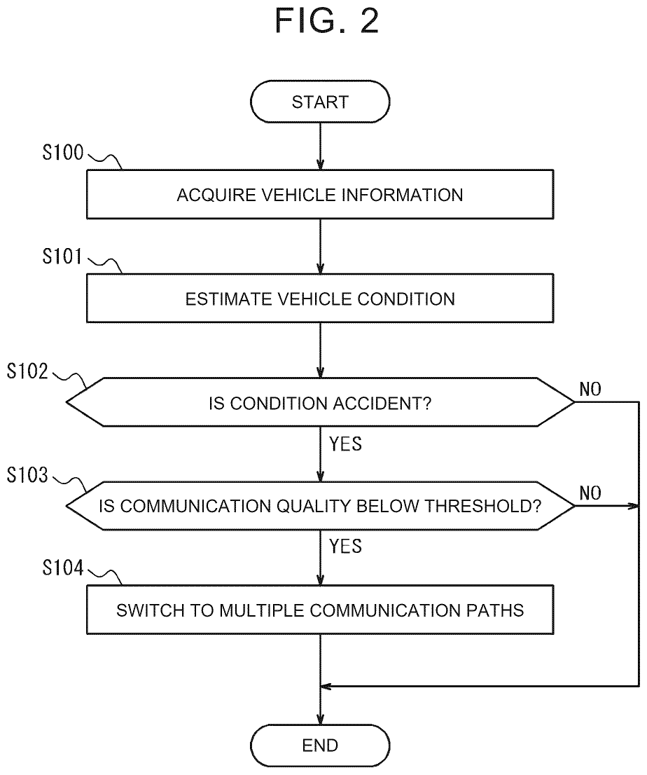

An operation of the in-vehicle device 10 according to the present embodiment will be described with reference to FIG. 2. The procedure of FIG. 2 is performed at any interval, e.g., every second, every 5 seconds.
S100: The control unit 13 of the in-vehicle device 10 acquires vehicle information.

Specifically, the control unit 13 acquires information that can be acquired using the sensor unit 14 such as acceleration, speed, and position of the vehicle 1. In addition, the control unit 13 acquires communication qualities and/or throughput of communication paths such as 5G, 4G, Wi-Fi, Bluetooth and vehicle-to-vehicle communication used in the communication unit 11. In addition, the control unit 13 acquires, for example, information on whether or not the airbag is operated.
S101: The control unit 13 estimates the condition of the vehicle 1 based on the vehicle information.

Specifically, when the airbag is activated, the control unit 13 may estimate that an accident has occurred in the vehicle 1. Alternatively, when the absolute value of the acceleration of the vehicle 1 is equal to or greater than the first threshold such as 15G, for example, the control unit 13 may estimate that an accident has occurred in the vehicle 1. Alternatively, the control unit 13 may estimate that an accident has occurred in the vehicle 1 when the airbag is activated and the acceleration is equal to or greater than the first threshold. The first threshold may be set based on, for example, a collision acceleration obtained by a collision experiment at a predetermined speed or the like.
S102: The control unit 13 determines whether the condition of the vehicle 1 is an accident.

Specifically, the control unit 13 proceeds to S103 when the condition of the vehicle 1 is an accident (S102—Yes), and ends the process when the situation is not an accident (S102—No). Alternatively, the control unit 13 may skip S103 and proceed to S104 when the condition of the vehicle 1 is an accident.
S103: The control unit 13 determines whether the communication quality of the communication unit 11 is less than the second threshold.

Specifically, the control unit 13 determines whether or not the communication quality of the communication currently used in the communication unit 11, such as 5G, is less than the second threshold, such as less than −100 dBm. When the communication quality is less than the second threshold (S103—Yes), the process proceeds to S104, and when the communication quality is not an accidental occurrence (S103—No), the process ends. Note that the communication quality may be expressed in units indicating the strength of the radio wave such as dBm described above. Further, the second threshold may differ depending on the communication standard, for example, 5G may be −100 dBm, 4G such as −85 dBm. The control unit 13 may use the throughput of the communication unit 11 instead of the communication quality of the communication unit 11.
S104: The control unit 13 switches from a single communication path to multiple communication paths.

For example, the communication unit 11 includes 5G, 4G, LTE, Wi-Fi, and a communication interface for inter-vehicle communication, and 5G may be used for communication. Here, the control unit 13 performs the switching such that not only 5G but also 4G, LTE, Wi-Fi, and the inter-vehicle communication can be used. Note that the control unit 13 may detect available communication path candidates when switching from a single communication path to multiple communication paths. For example, the communication unit 11 may include 5G, 4G, LTE, Wi-Fi, and communication interfaces for inter-vehicle communication, and 5G, Wi-Fi, and inter-vehicle communication may be available. Here, the control unit 13 detects 5G, Wi-Fi, and the inter-vehicle communication as available communication path candidates. Then, the control unit 13 may select two or more communication paths according to the condition of the vehicle 1 from the detected communication path candidates. For example, when the condition of the vehicle 1 is an accident occurrence, it is important to reliably transmit information on the accident to the server device 20 or the like. Therefore, the control unit 13 selects two or more communication paths in descending order of communication quality from the communication path candidates. For example, when 5G, Wi-Fi, and the inter-vehicle communication are communication path candidates, and the communication-quality order is the inter-vehicle communication and Wi-Fi, 5G, the control unit 13 selects the communication path in the order of the inter-vehicle communication and Wi-Fi, 5G. Further, for example, when the amount of data to be transmitted outside the vehicle is large, the throughput of the communication path becomes important. Therefore, the control unit 13 may select two or more communication paths in descending order of throughput according to the amount of the data to be transmitted to the outside of the vehicle. For example, when 5G, Wi-Fi, and the inter-vehicle communication are communication path candidates and the highest-throughput order is Wi-Fi, inter-vehicle communication, and 5G, the control unit 13 selects the communication path in the order of Wi-Fi, inter-vehicle communication, and 5G.

The procedure of FIG. 2 has been described only when the condition of the vehicle 1 is an accident. However, the condition of the vehicle 1 estimated by S101 is not limited to the occurrence of an accident in the vehicle 1, and may include any condition of the vehicle 1 that can be estimated using the vehicle information. For example, the control unit 13 may estimate that a failure has occurred in the vehicle 1 when the position of the vehicle 1 is a road shoulder or a roadside belt, the velocity of the vehicle 1 is 0 km/s, and the time of 0 km/s exceeds a predetermined time such as 10 minutes. For example, when the communication quality of the communication currently used in the communication unit 11 is less than the second threshold, the control unit 13 may estimate that the condition of the vehicle 1 is a weak electric field. In this case, the control unit 13 may perform the same process as in the case where the condition of the vehicle 1 is an accident in S102.

In addition, when the condition of the vehicle 1 changes, the control unit 13 may return multiple communication paths switched in S104 to a single communication path. For example, when the estimated condition of the vehicle 1 is a failure, the control unit 13 returns from the multiple communication paths to a single communication path when the position of the vehicle 1 becomes a road and the velocity of the vehicle 1 is not 0 km/s. Further, for example, when the communication quality of the communication used in the communication unit 11 becomes equal to or higher than the second threshold, the control unit 13 returns the communication from the multiple communication paths to a single communication path.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the in-vehicle device 10 may be distributed among a plurality of computers capable of communicating with each other.

Further, for example, an embodiment in which a general-purpose computer functions as the in-vehicle device 10 according to the above-described embodiment is also possible. Specifically, a program describing processing contents for realizing each function of the in-vehicle device 10 according to the above-described embodiment is stored in a memory of a general-purpose computer, and the program is read and executed by a processor. Therefore, the present disclosure can also be realized as a program that can be executed by the processor or a non-transitory computer-readable medium that stores the program.

What is claimed is:

1. An information processing method executed by an in-vehicle device mounted on a vehicle, the information processing method comprising:
acquiring information regarding whether an airbag of the vehicle has deployed, acceleration, and communication quality;
estimating that an accident has occurred in the vehicle when the airbag has deployed and an absolute value of the acceleration is greater than or equal to a first threshold; and
transmitting information related to the accident by switching from a single communication path to multiple communication paths when the communication quality is less than a second threshold.

2. An information processing method executed by an in-vehicle device mounted on a vehicle, the information processing method comprising:
acquiring vehicle information related to the vehicle;
estimating a condition of the vehicle based on the vehicle information; and
dynamically switching between a single communication path and multiple communication paths based on the estimated condition.

3. The information processing method according to claim 2, further comprising:
detecting communication path candidates that are available, when switching from the single communication path to the multiple communication paths; and
selecting two or more communication paths from the communication path candidates based on the condition.

4. The information processing method according to claim 3, wherein:
the condition includes occurrence of an accident;
the vehicle information includes communication quality of each of the communication path candidates; and
the in-vehicle device selects the two or more communication paths from the communication path candidates in descending order of the communication quality when the condition corresponds to occurrence of the accident.

5. The information processing method according to claim 3, wherein
the vehicle information includes throughput of each of the communication path candidates; and
the in-vehicle device selects the two or more communication paths in descending order of the throughput based on an amount of data to be transmitted outside the vehicle.
